(19) United States
(12) Patent Application Publication
(10) Pub. No.: US 2011/0049015 A1
(43) Pub. Date: Mar. 3, 2011

(54) WATER REMOVAL AND MANAGEMENT SYSTEM

(75) Inventors: Brian D. Babcock, Bloomington, MN (US); James Doyle, St. Louis Park, MN (US); Gregory L. Lavallee, Monticello, MN (US); Michael John Madsen, Chaska, MN (US); Philip Edward Johnson, Apple Valley, MN (US)

(73) Assignee: Donaldson Company, Inc., Bloomington, MN (US)

(21) Appl. No.: 12/827,353

(22) Filed: Jun. 30, 2010

Related U.S. Application Data
(60) Provisional application No. 61/236,653, filed on Aug. 25, 2009.

(51) Int. Cl. C10G 33/06; B01D 17/02; B01D 15/00; B01D 35/02; B01D 36/00

(52) U.S. Cl. 208/187; 210/205; 210/408; 210/409; 210/195.1; 210/167.01; 210/167.09; 210/167.31

(57) ABSTRACT

A system and method for removing and managing water in liquid hydrocarbons is disclosed. The system and method utilize a water absorbent filter, such as one that utilizes super absorbent polymers, cellulose, cotton or other suitable material to remove water from the system that is either present as free water or as dissolved moisture within the liquid hydrocarbon. The super absorbent polymer filter can be regenerated through the introduction of a dried liquid hydrocarbon, through the use of an air drying system, or a combination of both.

### TECHNICAL FIELD

This disclosure relates generally to systems for the removal and management of water in hydrocarbon liquids.

### BACKGROUND

Many mechanical systems rely upon liquid hydrocarbons for fuel, lubrication and/or power transmission. These types of mechanical systems can be negatively affected by the presence of excessive water in the system, especially free water. Free water can develop within a system through a variety of ways, such as by flashing to steam out of the liquid hydrocarbon, by condensing out of the liquid hydrocarbon itself or by condensing out of air or water vapor that may be present in the dead space of the liquid hydrocarbon storage tank. Free water can also develop from heat exchanger leaks and wash downs of equipment. One solution that has been developed to eliminate the presence of water in liquid hydrocarbons is the use of a water separator with a collection reservoir that has a water absorption filter. Examples of water absorption filter materials are cellulose and super absorbent polymers (SAP). Water can also be removed from a system through the use of coalescers, centrifuges, and vacuum dehydration systems. Other solutions for removing water in a tank include forcing dried air through the dead space of the tank or through the fluid in the tank. While these solutions can be effective in certain applications, better solutions for the removal and management of water in liquid hydrocarbon systems are desired.

### SUMMARY

A system is disclosed comprising a tank having an interior volume for holding a liquid fuel or oil, a water absorbent filter, which may comprise super absorbent polymers (SAP), in liquid communication with the interior volume of the tank, an air dryer in fluid communication with the water absorbent filter and a fume filter downstream of the air dryer. The water absorbent filter may be oriented inside or outside of the interior volume of the tank. Further, the air dryer and the fume filter may be oriented outside of the interior volume of the tank.

A system is also disclosed for removing at least some water from liquid fuel or oil comprising a tank having an interior volume holding a liquid fuel or oil, a water absorption filter, such as a super absorbent polymer (SAP) filter, downstream of and in liquid communication with the interior volume of the tank, a particulate filter downstream or upstream of the SAP filter to remove particulate contaminant from the fuel or oil and apparatus downstream of and in liquid communication with the particulate filter constructed and arranged to utilize at least some of the filtered fuel or oil. Also disclosed is a return channel directing at least some of the fuel or oil from the apparatus back to the tank and an air dryer upstream of and in fluid communication with the interior volume of the tank to remove at least some moisture from the tank. In lieu of an air dryer, a dry gas from another process may be used. Nitrogen gas will also work to dry water from the liquid. A breather filter, which may include a fume filter, may also be in air communication with the tank. Additionally, the SAP filter is constructed and arranged to remove at least some water from the fuel or oil and also to be regenerated by the fuel or oil. The disclosed apparatus may be an engine, a gearbox, or a hydraulic system. A second water absorption filter is also disclosed in a configuration where the first and second water absorption filters can be regenerated directly by the air drying system.

A method to manage the amount of water present in a system having liquid fuel or oil is also disclosed. Such a method may comprise the steps of directing dry air into a tank holding the liquid fuel or oil wherein the fuel or oil has water entrained therewithin; directing the fuel or oil from the tank and through a water absorbent filter, such as a super absorbent polymer (SAP) filter, to remove at least some of the water or to regenerate the SAP filter; directing the fuel or oil from the SAP filter through a second filter to remove at least some contaminant from the fuel or oil; directing the filtered fuel or oil from the second filter to apparatus utilizing at least some of the filtered fuel or oil; and directing at least some of the filtered fuel or oil from the apparatus back to the tank. In lieu of dry air, a dry gas, such as nitrogen may also be used. By the use of the term “entrained”, it is meant that water exists in the presence of the liquid fuel or oil as free water in the same vessel that stores the liquid fuel or oil or as dissolved moisture within the liquid itself.

### BRIEF DESCRIPTION OF THE DRAWINGS

FIG. 1 is a schematic view of a first embodiment of a water management and removal system.

FIG. 2 is a schematic view of a second embodiment of a water management and removal system.

FIG. 3 is a schematic view of a third embodiment of a water management and removal system.

FIG. 4 is a schematic view of a fourth embodiment of a water management and removal system.

FIG. 5 is a schematic view of a fifth embodiment of a water management and removal system.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

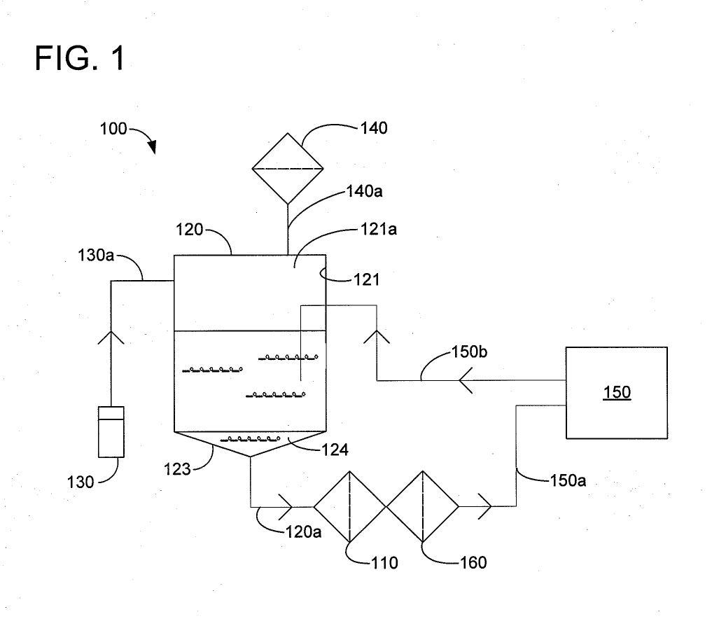

As illustrated in FIGS. 1-3, three embodiments of a water management and removal system 100, 200, 300 are disclosed. One aspect of each disclosed embodiment is a super absorbent polymer or SAP filter 110, 210, 310. In general, super absorbent polymers or SAPs are useful in applications where it is necessary or desired to absorb water. Examples of SAPs are polymers and copolymers of polyacrylates, polyacrylic acids, polyacrylamides, polyesters, polysaccharides. SAPs are particularly useful in water absorption applications because they can absorb a very large amount of water per unit weight of SAP. For example, SAPs can absorb up to 500 times their weight in water in certain configurations and applications. Another feature of SAPs is that absorbed water within the SAP can be driven out such that the SAP can be made available for future water absorption. One method for drying out SAPs includes applying pressure to the SAP. Because SAP expands greatly as moisture is absorbed, placing pressure on the SAP to reduce its volume will cause the dissolved moisture to be expelled. Another method for drying SAP is to expose the SAP to elevated temperatures. Yet another method for drying SAP is to expose the material to the atmosphere or relatively dry air where the moisture will wick out of the fibers and evaporate. This dynamic is also possible when exposing the SAP to a relatively dry liquid, such as a liquid hydrocarbon. In this case, the dry liquid will draw the water out of the SAP up to a point where the liquid hydrocarbon is near its saturation point. Additionally, it should be noted that SAP can become mobile within a liquid system and can cause contamination within the system itself if not contained sufficiently within a housing. SAP filter 110, 210, 310 is constructed to prevent the SAP material from contaminating system 100, 200, 300 in this way.

In the particular embodiment shown in FIG. 1, SAP filter 110 is shown as being used in a liquid fuel or oil system 100 comprising a tank 120. Tank 120 is for storing the liquid fuel or oil 122. Tank 120 can be a storage vessel for use in a vehicle or for use in a stationary application, such as a bulk oil or fuel storage tank. As shown, tank 120 has an interior volume 121 wherein the liquid fuel or oil 122 is stored. Above the liquid fuel or oil 122 is a head space volume 121a. Tank 120 also has a bottom portion 123 at which line 120a provides liquid communication between the tank 120 and the SAP filter 110. The installation of line 120a at the bottom portion 123 of tank 120 is advantageous insofar as that any free water 124 that may collect at the bottom portion 123 of tank 120 will be directed to SAP filter 110 where it can be absorbed.

It should also be noted that SAP filter 110 may be replaced by water absorption filters of other types without departing from many of the concepts presented herein. For example, cellulosic water absorption filters or cotton based filters, may be used. By the use of the term “water absorption filter” it is meant to include at least cellulosic based filters and SAP based filters.

Also shown in FIG. 1 is breather filter 140. Filter 140 is for allowing atmospheric air leave tank 120 as the level of the liquid fuel or oil 122 rises within tank 120 or as dried air is introduced into head space volume 121a via an air drying system 130, discussed later. Breather filter 140 is also for scrubbing fumes that are present in head space volume 121a before the air is ejected into the atmosphere so as to minimize the negative effects on the environment. Optionally, the ejected air can be routed to another part of the system, such as an engine air intake. In the embodiment shown, breather filter 140 is in fluid communication with head space volume 121a via line 140a. Breather filter 140 can also be configured with a desiccant material or an adsorbent to dry out atmospheric air that may need to enter the tank through breather filter 140 as the liquid level in the tank 120 is reduced and a vacuum or partial vacuum is created.

Another aspect of the disclosure is air drying system 130. Air drying system 130 is used to pump dry air into the head space volume 121a of the tank 120 via line 130a. The dry air delivered by air drying system 130 can be created in a variety of ways. For example, atmospheric air can be compressed to condense and remove the moisture. Atmospheric air can also be dried through the use of refrigeration dryers, pressure swing adsorption dryers, membrane dryers and/or a combination of coolers and blowers. In some applications a combination of air compression and filters may be used. Further, dry gases from other sources or processes within the system may be used instead of dry air. Nitrogen can also be used. By the use of the term “dry gas” and it is meant to include any gas that is capable of absorbing moisture from a liquid hydrocarbon and/or from the head space of a tank holding a liquid hydrocarbon. The term “dry gas source” should be taken to mean any system, including those mentioned above, capable of producing and/or delivering a dry gas. One skilled in the art will appreciate that the water absorbing capability of the dry gas will increase as the moisture content within the dry gas is lowered. In many applications, it is beneficial to utilize a dry gas having a very low initial moisture content. The effect of passing a dry gas through the head space volume 121a of tank 120 is that the dry gas will absorb moisture directly out of the liquid fuel or oil 122, thus creating a drying effect.

Air drying system 130 is particularly useful for drying moisture out of liquid fuel or oil 122 when liquid fuel or oil 122 is agitated or has other movement within tank 120. This is true even in circumstances where the total amount of water within the tank 120 exceeds the saturation point of the liquid fuel or oil 122. However, in circumstances where the liquid fuel or oil 122 is essentially stationary or stagnant, the length of time for air drying system 130 to remove the moisture from the liquid fuel or oil 122 can dramatically increase. This is especially true in situations where free water 124 that has collected at the bottom of the tank is slow to absorb back into the liquid oil or fuel. This is the case even when the water present in the liquid oil or fuel is well below the saturation point. In any event, air drying system 130, given adequate time to dehydrate liquid oil or fuel 122, can reduce the moisture content of liquid oil or fuel 122 to a percent saturation of about 3%.

Other factors that affect the effectiveness of air drying system 130 include the temperature of the liquid fuel or oil 122 and the flow rate of dried air introduced into the head space volume 121a of tank 120. As the temperature of the liquid fuel or oil 122 is increased, the air drying system 130 becomes more effective. Thus, a system which includes a mechanism for heating the liquid fuel or oil 122, which is necessary for some end use applications and/or occurs in end use applications, will have the beneficial effect of allowing the air drying system 130 to remove a greater degree of moisture from the liquid fuel or oil 122. This benefit occurs because hot fuel or oil has a higher saturation point than fuel or oil at a lower temperature and will therefore have a lower percent saturation at higher temperatures for a fixed amount of dissolved water. With respect to the air flow rate from the air drying system 130, a roughly proportional drying rate is achieved with a change in air flow rate in some applications. For example, reducing the air flow rate by half can double the length of time that it will take to dehydrate the liquid fuel or oil 122 under certain circumstances. However, it should be noted that these relationships occur within a reasonable range of values and that there is also a minimum and maximum rate within which each particular process will optimally operate.

Yet another aspect of system 100 is apparatus 150. Apparatus 150 represents an end use device that is capable of utilizing the liquid fuel or oil 122 stored within tank 120. By way of non-limiting examples, apparatus 150 may be an engine, a hydraulic system or a gearbox. As shown in FIG. 1, apparatus 150 is in liquid communication with tank 120 via lines 120a and 150a where a supply of liquid fuel or oil 122 can be delivered to apparatus 150. Apparatus 150 may include a pump (not shown) to achieve this purpose. Apparatus 150 is also shown as being protected from potentially harmful contaminants by particulate filter 160. As shown, particulate filter 160 is downstream of SAP filter 110 although other locations may be desirable for a particular application. Many types of filters capable of removing particulate matter from a liquid fuel or oil are useful for this purpose. In applications where apparatus 150 does not consume all of the delivered liquid fuel or oil 122, the unused portion can be returned to tank 120 via channel or line 150b. In many applications, the unused portion of liquid fuel or oil 122 is heated by apparatus 150 or a separate device which, as mentioned previously, has the beneficial effect of enhancing the moisture removal process. The system will also effectively remove water from the liquid fuel or oil in applications where all the liquid fuel or oil is consumed at apparatus 150 and no return line 150b is present.

In operation, system 100 will effectively maintain the moisture content of the liquid fuel or oil 122 at an acceptable level and will also prevent the delivery of free water 124 to apparatus 150 which could cause catastrophic damage. When SAP filter 110 is used in conjunction with air drying system 130, such as in the configuration shown in FIG. 1, an enhanced system is developed. One beneficial aspect of this combination it is that SAP filter 110 can be sized and configured to absorb an initial amount of water within the system that may be difficult to extract from the liquid fuel or oil 122 with air drying system 130. Such a circumstance can occur for a variety of reasons. For example, the liquid temperature could be initially low at system start-up, free water could have collected in the tank through condensation during a stagnant period, previously dissolved moisture could flash to steam, or the fuel system could have been unexpectedly contaminated with a large volume of water. Additionally, leaks in heat exchangers and rain can also introduce free water into the system. As a result, the use of SAP filter 110 in system 100 will enable the liquid fuel or oil 122 to be maintained at or even slightly below the moisture saturation point under a variety of circumstances.

However, another dynamic occurs after the system has been allowed to run for a period of time. Once air drying system 130 is capable of adequately removing moisture from liquid oil or fuel 122, the moisture level in the liquid or fuel 122 will be reduced to well below saturation, especially if apparatus 150 adds heat to the system. As the liquid oil or fuel 122 continues to become dehydrated below the saturation point, the relatively dry fuel will actually begin to absorb the initially captured moisture out of SAP filter 110. As this occurs, the liquid fuel or oil 122 will continue to be dried by air drying system 130 and SAP filter 110 will continue to be dried by liquid oil or fuel 122 such that equilibrium is maintained. Initial tests show that SAP material will give up at least 80% of the dissolved moisture when exposed to a liquid hydrocarbon initially at 55° C. and having a percent saturation of about 3%. Thus, liquid fuel or oil 122 will automatically regenerate SAP filter 110 such that SAP filter 110 becomes available to absorb additional moisture when new free water enters the system or when air drying system 130 is no longer available or capable of removing moisture from the system. Thus, SAP filter 110 and air drying system 130 operate cooperatively to result in an effective water management system that automatically regenerates itself without the need for special controls or processes. Even more, system 100 requires no direct supervision and does not need to be shut down in order to regenerate the SAP filter 110. Further, system 100 will work effectively to remove and manage water under both unsteady and steady state conditions. As a result, system 100 is potentially smaller, more compact, more energy efficient and more efficient at removing water than typical existing technologies.

Another feature of the disclosure is that the SAP filter 110 can be configured to act as a safety device for apparatus 150. SAP material expands significantly as it absorbs water. By taking advantage of this property, a filter housing can be constructed such that flow will be blocked off to apparatus 150 by the expanding SAP material. Thus, SAP filter 110 can be configured to allow flow to pass through the filter under a normal expansion range, but to shut off flow past a certain expansion point. Thus, when SAP filter 110 is exposed to a water concentration that is in excess of its capacity to safely handle, the SAP material in the filter will expand to shut flow off to the system. Thus, the shut off action of SAP filter 110 will protect susceptible end use equipment from potentially catastrophic damage.

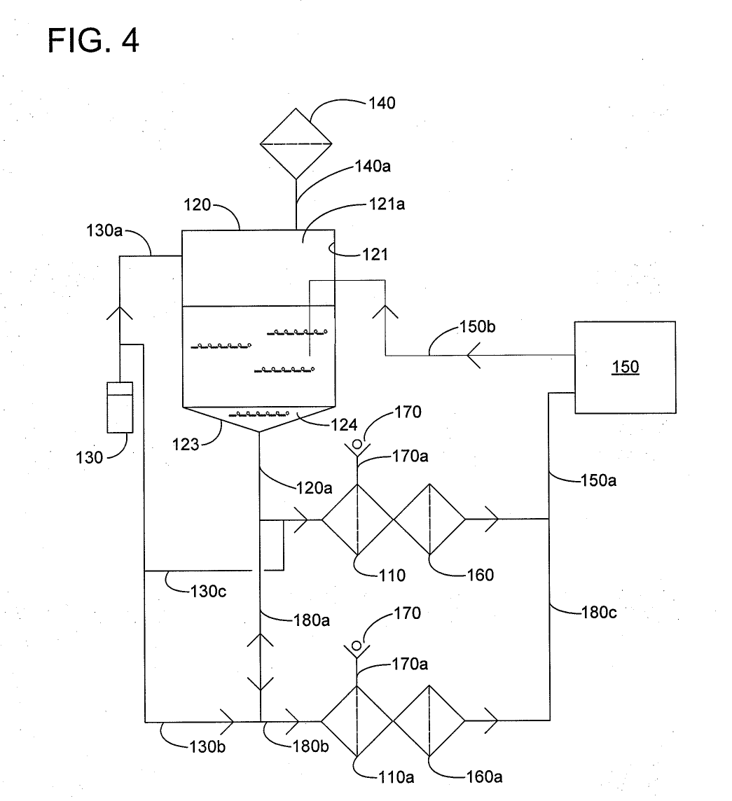

FIG. 4 shows a modified embodiment of the system shown in FIG. 1, the primary difference being the addition of a second water absorption filter, SAP filter 110a. Therefore, the same figure numbers have been used wherein elements of the schematics are similar. As shown, SAP filter 110a is placed in a parallel arrangement with SAP filter 110 via lines 180a, 180b and 180c. This arrangement allows for the system to operate with only one SAP filter at a time and adds flexibility to the system in at least two ways. First, should one of the SAP filters fail or shut off fuel flow to apparatus 150, the other SAP filter can be brought on-line such that apparatus 150 can continue to operate. Second, the SAP filter that is not in use can be regenerated while it is off-line. The alternation of the SAP filters can be controlled by a system (not shown) such that the filters are regenerated on a time based schedule, fluid pressure drop or another relevant variable. In the embodiment shown in FIG. 4, additional compressed air lines 130b and 130c are piped to each SAP filter 110, 110a such that the filters can be directly regenerated by the air drying system 130. In such an application, it is beneficial to install vents 170 such that the air injected into the SAP filters, 110 and 110a can escape the system. FIG. 4 also shows an additional particulate filter 160a that functions in a similar manner as that described for particulate filter 160. One skilled in the art will appreciate that FIG. 4 is a schematic description of the system and does not necessarily show all required piping, valves and controls that an actual system would require.

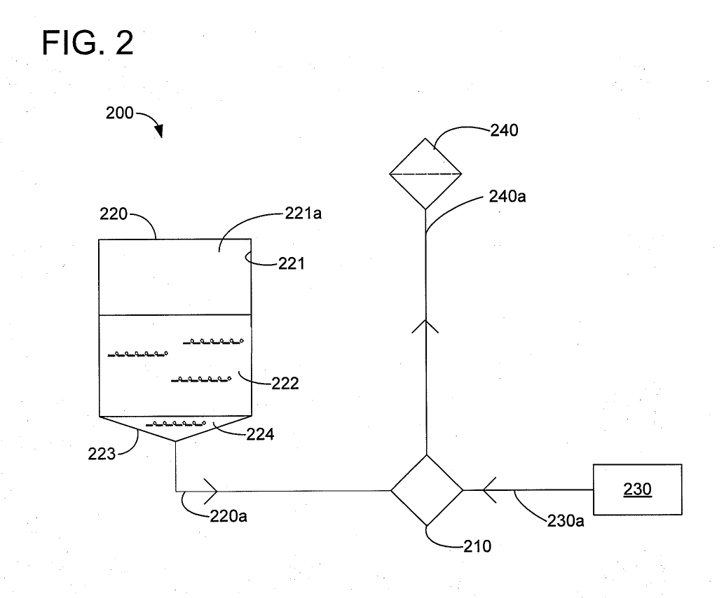

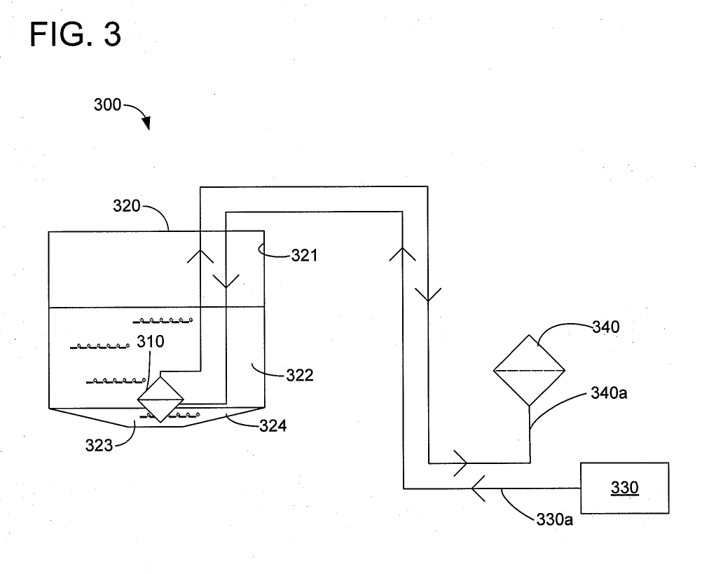

FIGS. 2, 3 and 5 show alternative embodiments of systems that are particularly useful in bulk storage applications that also utilize an SAP filter. Many of the elements of the embodiments shown in FIGS. 2 and 3 are similar to those found in the embodiment of FIG. 1. As such, the entire description of FIG. 1 is hereby incorporated into the descriptions for the embodiments of FIGS. 2 and 3.

FIGS. 2 and 3 show systems 200, 300 for storing and managing the moisture content of a liquid oil or fuel 222, 322. In the exemplary embodiment shown, system 200, 300 includes an SAP filter 210, 310; a tank 220, 320; an air drying system 230, 330; and a filter 240, 340. Many aspects of each of these elements are similar in nature to corresponding elements of system 100. Therefore, these elements will be described here to the extent that they differ significantly from the disclosure for system 100.

One aspect of system 200, 300 is tank 220, 320 which is for storing liquid oil or fuel 223. Tank 220, 320 can be a storage vessel for use in a vehicle or in a stationary application, such as a bulk oil or fuel storage tank. In the exemplary embodiment shown at FIGS. 2 and 3, tank 220, 320 has an interior volume 221, 321; a head space volume 221a, 321a; and a bottom portion 223, 323 that are similar to that described for system 100. In contrast to the embodiment shown in FIG. 1, tank 220, 320 is not shown as being directly connected to an air drying system or a fume breather filter. However, it should be appreciated that such a configuration may be desirable in certain applications. Additionally, it should be appreciated that in systems where the tank 220, 320 is stationary, as is the case in bulk oil or fuel storage applications, that a large quantity of water can form at the bottom of the tank. If this water is not removed, then it is possible that microbial growth will occur that will contaminate the fuel. Microbial growth represents a significant problem in the bulk fuel and oil storage industry.

The SAP filter 210 of FIG. 2 is for removing moisture from tank 220 and from liquid oil or fuel 222. As shown, SAP filter 210 is in fluid communication with tank 220 via line 220a. SAP filter 210 is also in fluid communication with air drying system 230 and filter 240 via lines 230a and 240a, respectively. In the configuration shown, SAP 210 is constructed with a liquid inlet port to which line 220a is attached, an air inlet port to which line 230a is attached and an air outlet port to which line 240a is attached. In operation, liquid oil or fuel 222 and/or free water 224 that has collected at the bottom of tank 220 flow through line 220a and into SAP filter 210. Once the liquid oil or fuel 222 or the free water 224 contacts the SAP filter 210, the SAP filter 210 begins to absorb moisture.

The SAP filter 320 of FIG. 3 is also for removing moisture from tank 320 and from liquid oil or fuel 322. As shown, SAP filter 310 is in fluid communication with tank 320 by virtue of being directly placed within the interior volume 321 of tank 320. In the configuration shown, SAP filter 310 is submerged in the liquid oil or fuel 322 and located at the bottom portion 323 of tank 320. In the configuration shown, SAP filter 310 is constructed to allow the liquid oil or fuel 322, or any free water 324 that has collected at the bottom of tank 320, to enter the SAP filter 310. Once the liquid oil or fuel 322 and/or free water 324 contacts the SAP filter 310, the SAP filter 310 begins to absorb moisture. A benefit of placing the SAP filter 310 directly within the tank 320 is that the system 300 can be installed in retrofit applications where a connection port may not exist at the bottom of the tank 320. System 300 is also useful for in ground tanks where it is not possible to make a connection to the bottom of the tank 320.

In contrast to the embodiment of FIG. 1, air drying system 230, 330 delivers dried air directly to SAP filter 210, 310 through line 230a, 330a. The dry air that is injected into SAP filter 210, 310 from air drying system 230, 330 acts to absorb the moisture out of the SAP filter 210, 310 and to the atmosphere via line 240a, 340a and fume filter 240, 340. Thus, the SAP filter 210, 310 can be continually regenerated such that SAP filter 210, 310 always remains available for moisture absorption. In some applications, a control system (not shown) can be provided to cycle the air drying system 230, 330 on and off to maintain a specific moisture content level for the liquid oil or fuel 222, 322 in the tank 220, 320. A control system can also be installed to cycle the air drying system 230, 330 on and off based on sensing an amount of free water 224, 324 that has collected at the bottom of the tank.

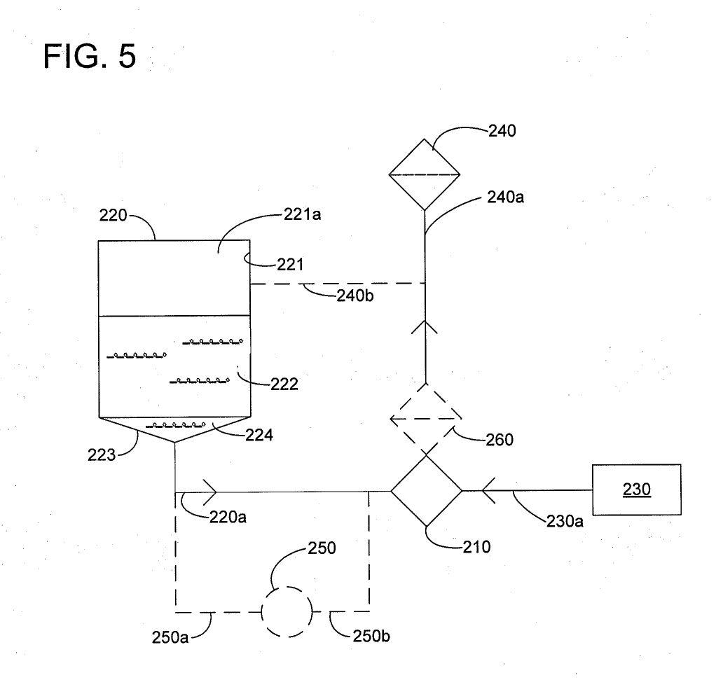

The embodiment of FIG. 5 is similar in many aspects to that shown and described for FIG. 2. Therefore, the same figure numbers have been used wherein elements of the schematic are similar. The primary difference shown in FIG. 5 is the addition of a kidney loop pump 250, particulate filter 260 and return channel/line 240b. As shown, kidney loop pump 250 is piped into line 220a via lines 250a and 250b. This arrangement allows for pump 250 to circulate liquid oil or fuel 222 out of tank 220, through SAP filter 210 and particulate filter 260 and back into tank 220 via lines 240a and 240b. A check valve or isolation valve (not shown) can be installed in line 220a between the connection points of lines 250a and 250b to prevent the reverse flow of liquid through line 220a while pump 250 is in operation. The addition of this type of circulation loop is particularly beneficial in a bulk fuel application because there can be long periods where the liquid oil or fuel 222 is stagnant. In such a situation, the gravity flow rate to SAP filter 210 of liquid from tank 220 is sometimes too small to effectively remove water from tank 220 and/or liquid oil or fuel 222. Thus, the addition of a pump allows for the system to control water levels in the liquid oil or fuel 222 and tank 220 in a manner that is independent of the actual use of the fluid in the tank. The cycling of pump 250 can be controlled by a variety of conditions. For example, pump 250 can be controlled based upon the measured moisture content of the liquid oil or fuel 222 within the tank 220, the sensed presence of free water at the bottom 223 of the tank 220 and/or a timed schedule. One skilled in the art will appreciate that FIG. 5 is a schematic description of the system and does not necessarily show all required piping, valves and controls that an actual system would require.

The above disclosed systems can be utilized as discussed above and also according to a method wherein dry air is directed into a tank 120 holding the liquid fuel or oil 122 wherein the fuel or oil 122 has water entrained therewithin. The fuel or oil 122 can also be directed from the tank 120 and through a super absorbent polymer (SAP) filter 110 to remove at least some of the water or to regenerate the SAP filter 110. The fuel or oil 122 can also be directed from the SAP filter 110 through a particulate filter 160 to remove at least some contaminant from the fuel or oil 122 and directed from the particulate filter 160 to apparatus 150 utilizing at least some of the filtered fuel or oil 122. From apparatus 150, some of the filtered fuel or oil 122 can be directed from the apparatus 150 back to the tank 120.

The above includes examples incorporating inventive principles. Many embodiments can be made.

We claim:

1. A system for removing at least some water from liquid fuel or oil, the system comprising:
(a) a tank having an interior volume for holding a liquid fuel or oil;
(b) a first water absorbent filter in liquid communication with the interior volume of the tank, the filter being constructed and arranged to absorb and remove at least some of the water from the liquid fuel or oil; and
(c) a dry gas source to remove at least some moisture from the first water absorbent filter and/or the liquid fuel or oil.

2. The system of claim 1, wherein the first water absorbent filter comprises super absorbent polymers (SAP).

3. The system of claim 2, wherein the first water absorbent filter is oriented outside of the interior volume of the tank.

4. The system of claim 2, wherein the first water absorbent filter is oriented within the interior volume of the tank.

5. The system of claim 2, wherein the first water absorbent filter is directly connected to and regenerated by the dry gas source.

6. The system of claim 2, wherein the first water absorbent filter is regenerated by the liquid fuel or oil.

7. The system of claim 2, wherein the first water absorbent filter is oriented in the interior volume of the tank.

8. The system of claim 2, further comprising:
(a) a particulate filter to remove contaminant from the fuel or oil;
(b) a circulation pump in fluid communication with the water absorbent filter and the particulate filter, the circulation pump directing at least some of the fuel or oil from the tank to the water absorbent filter; and
(c) a return channel in fluid communication with the water absorbent filter and the particulate filter directing at least some of the fuel or oil from the water absorbent filter to the tank.

9. The system of claim 2, wherein the air dryer and a fume filter are oriented outside of the interior volume of the tank.

10. The system of claim 2, further comprising:
(a) an apparatus downstream of and in liquid communication with the first water absorbent filter, the apparatus being constructed and arranged to utilize at least some of the filtered fuel or oil; and
(b) a return channel directing at least some of the fuel or oil from the apparatus back to the tank;

11. The system of claim 10 wherein the apparatus includes an engine, or a gearbox, or a hydraulic system.

12. The system of claim 10, further comprising a breather filter in fluid communication with the tank.

13. The system of claim 10, further comprising a second water absorbent filter in liquid communication with the interior volume of the tank, the filter being constructed and arranged to absorb and remove at least some of the water from the liquid fuel or oil; and

14. The system of claim 10, wherein the second water absorbent filter comprises super absorbent polymers (SAP).

15. The system of claim 14, wherein the dry gas source is arranged within the system to selectively regenerate the first and second water absorbent filters.

16. The system of claim 15, further comprising:
(a) a first particulate filter in fluid communication with the first water absorption filter; and
(b) a second particulate filter in fluid communication with the second water absorption filter.

17. A method to manage the amount of water present in a system having liquid fuel or oil; the method comprising:
(a) directing dry air into a tank holding the liquid fuel or oil; the fuel or oil having water entrained therewithin;
(b) directing the fuel or oil from the tank and through a water absorbent filter to remove at least some of the water or to regenerate the water absorbent filter;
(c) directing the filtered fuel or oil from the second filter to apparatus utilizing at least some of the filtered fuel or oil; and
(d) directing at least some of the filtered fuel or oil from the apparatus back to the tank.

18. The method of claim 17, wherein the water absorbent filter comprises super absorbent polymers (SAP).

19. The method of claim 18, further comprising the step of directing the fuel or oil from the SAP filter through a second filter to remove at least some contaminant from the fuel or oil.

20. The method of claim 18 wherein the step of directing the filtered fuel or oil from the second filter to apparatus includes directing the filter fuel or oil to an engine, or a gearbox, or a hydraulic system.
